(19) United States
(12) Patent Application Publication
(10) Pub. No.: US 2006/0133281 A1
(43) Pub. Date: Jun. 22, 2006

(54) System for managing round trip time of a transmission control protocol and supporting method and apparatus

(75) Inventors: Michael S. Witherell, Chicago, IL (US); Dennis W. Gilliland, St. Charles, IL (US)

Correspondence Address: MOTOROLA, INC., 1303 EAST ALGONQUIN ROAD, IL01/3RD, SCHAUMBURG, IL, 60196, US

(73) Assignee: Motorola, Inc.

(21) Appl. No.: 11/017,451

(22) Filed: Dec. 20, 2004

(51) Int. Cl. H04J 3/14; H04L 12/26

(52) U.S. Cl. 370/238

(57) ABSTRACT

In the present technique of round trip time management, an acknowledgment packet received (204) on a wireless network is first buffered (210) to a memory buffer. A time delay is then added (214) to an assigned departure time of the acknowledgment packet, which at least substantially stabilizes the round trip times of a transmission control protocol transmitter. As a result, a congestion control feature of the transmission control protocol transmitter is prevented from being triggered by a false detection of a network congestion.

### TECHNICAL FIELD

This invention relates generally to round trip time management for a transmission control protocol.

### BACKGROUND

In recent years, numerous new features that have been traditionally available only at home are now becoming standards in cellular telecommunication networks. One of the most notable features is the availability of the Internet through the use of cell phones. Today, with all these available features on cell phones, there is practically no difference between computers and cell phones. To avoid confusion, a single term will be used to describe the various devices that can work with other multiple networks, such as the Internet. Specifically, a mobile station will be used to refer to any device, which may include, but is not limited to, a desktop computer, a laptop computer, a personal digital assistant, and/or a cell phone, that uses a specific network, such as a cellular network, for access to other networks.

Data packets are generally transferred through the standard transmission control protocol (“TCP”) via the Internet. The TCP, as well known in the art, tracks the transmission of data packets using a round trip time (“RTT”) that is used to set acknowledgement timers of the transmission. RTT is a measure of the time it takes for a data packet to travel from a node, across a network to another node, and back. Thus, for each data packet transmitted through the TCP, an RTT is measured to determine the current delay of the transmission of that particular data packet. Typically in a wired network, the RTT of the data packets is fairly consistent, because peaks and interruptions are less likely to occur in a wired network. This consistency, however, is not always true in a wireless network, and especially a cellular network where peaks and interruptions are almost inherent in the network itself. Because sharp increases in RTTs can cause timeouts, which are treated by the TCP as network congestion, the TCP responds by decreasing the transmission window size and reduces the throughput rate.

For example, to avoid data packets from being dropped, the link-level automatic repeat request (“ARQ”) protocols used by 3G cellular systems generally retransmit data packets, which are generally framed in protocol data units, that were lost over the radio interface. This, however, introduces large variations in delay. The TCP, in turn, views these delay variations as network congestion when in fact they are more or less part of the normal operation of the 3G cellular systems. The problem is that these delay variations can trigger the TCP's congestion control feature, which decreases the transmission window size and reduces the throughput rate. The reduction of the throughput rate, however, does not necessarily improve the delay but rather unnecessarily causes the radio bearer to be underutilized.

Most current efforts to address this problem focus on configuring or modifying the TCP to work with the characteristics of the cellular systems. These prior methods, however, deviate from the use of the standard TCP protocol, which is already widely used for Internet communications. As a result, by modifying the TCP protocol, there may be compatibility issues in cases where the device may not be able to handle the modified TCP protocol.

### BRIEF DESCRIPTION OF THE DRAWINGS

The above needs are at least partially met through provision of the RTT management process described in the following detailed description, particularly when studied in conjunction with the drawings, wherein:

FIG. 1 comprises a block diagram of an exemplary wireless communication system suitable for various embodiments of the invention;

FIG. 2 comprises a block diagram of a radio network controller according to various embodiments of the invention;

FIG. 3 comprises a signal flow diagram of a transmission call diagram according to various embodiments of the invention;

FIG. 4 comprises a flow chart diagram of a receiving process of a data packet according to various embodiments of the invention;

FIG. 5 comprises a flow chart diagram of a receiving process of an acknowledgement packet according to various embodiments of the invention;

FIG. 6 comprises a flow chart diagram of a receiving process of a data packet according to an embodiment of the invention; and

FIG. 7 comprises a flow chart diagram of a receiving process of an acknowledgement packet according to an embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments of the present invention. Also, common and well-understood elements that are useful or necessary in a commercially feasible embodiment are typically not depicted in order to facilitate a less obstructed view of these various embodiments of the present invention.

### DETAILED DESCRIPTION

Generally speaking, pursuant to these various embodiments, an RTT management technique has been provided. Specifically, a received acknowledgement packet is buffered into a memory buffer, and a time delay is added to an assigned departure time of the acknowledgement packet. The acknowledgement packet is then forwarded according to this added time delay. In various embodiments the time delay, which may be based on a mean delay value and a mean variance value, substantially prevents the congestion control feature of the TCP from being triggered and/or stabilizes the RTTs on the TCP. For one specific embodiment, the time delay is assessed based on a departure time of at least one previously transmitted acknowledgement packet. In various teachings, the mean delay value and the mean variance value are assessed using a plurality of system RTTs of other acknowledgment packets in the system. In one embodiment, a variance value is assessed based on the mean variance value and a packet variance value obtained from the RTT of the acknowledgement packet. The packet variance value can be further based on a predefined target variance value, and the variance value can be further based on a filter coefficient.

In one embodiment, the arrival time of the data packet that corresponds to the acknowledgement packet is tracked and stored to a data structure. An assessment is done to verify that the acknowledgement packet has been previously received. If the acknowledgement packet has been previously received, it is forwarded. Otherwise, it is buffered since this is a new acknowledgement packet. In various teachings, the adding of the delay includes determining whether a mean delay value, which is obtained from multiple system RTTs of other acknowledgement packets, corresponds in at least a predetermined way to a predefined target delay value. When the mean delay value corresponds to the predefined target delay value, a delay value is assessed by adding the variance value to the mean delay value. Otherwise, the delay value is assessed by subtracting the variance value from the mean delay value. When the delay value is assessed by adding the variance value to the mean delay value, in various teachings, it is further determined whether the delay value corresponds in at least the predetermined way to a mean value that is based on the mean delay value and the mean variance value. If so, the delay value is further set to the mean value. With the delay value obtained, the acknowledgment is forwarded based on this delay value.

Through the embodiments of various teachings, the delay variation of the various wireless networks is controlled, which reduces the likelihood of falsely triggering the TCP's congestion control feature. As a result, the radio bearer can be used with higher utilization in addition to the TCP throughput being increased. This would positively affect common key performance indicators, such as file transfer protocol (“FTP”) download rate and hypertext transfer protocol (“HTTP”) load time. Moreover, since the various teachings modify the characteristics of the wireless network to work with existing TCP implementations, this allows fuller use of the radio bearers to connect with the TCP entities on the Internet without requiring changes to those TCP entities. As such, the implementations of these various teachings are simpler than prior methods.

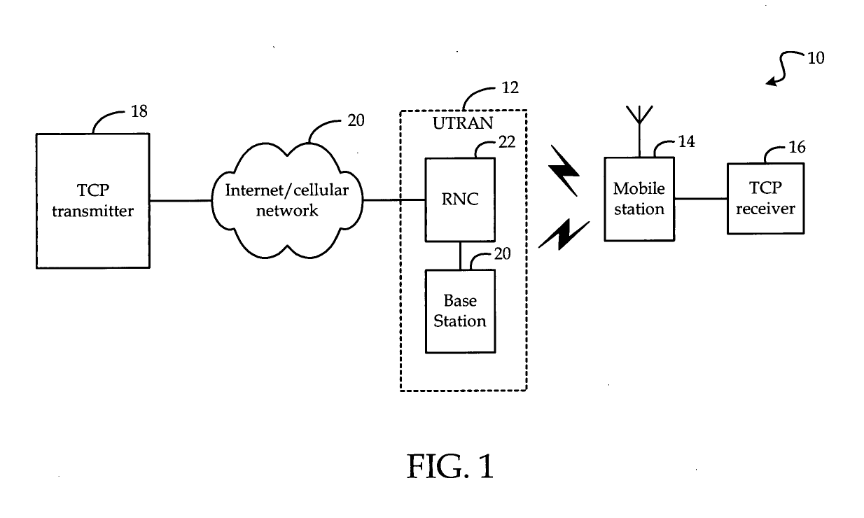

Referring now to the drawings, and in particular to FIG. 1, for purposes of providing an illustrative but nonexhaustive example to facilitate this description, a specific operational paradigm using a communication system is shown and indicated generally at 10. Those skilled in the art, however, will recognize and appreciate that the specifics of this illustrative example are not exhaustive of the invention and that the teachings set forth herein are applicable in a variety of alternative settings. For example, since the various teachings are not platform dependent, they can be applied to broadcast and multimedia initiatives in a 3GPP or a 3GPP2 system. Any digital broadcast services or digital satellite services are also applicable. In fact, a wired network implementation may also be desired if it experiences peaks and interruptions. As such, the various teachings described can be implemented in any network that may experience peaks and interruptions as part of the normal operation of the network. Thus, these various platform and network implementations are within the scope of the invention, and various embodiments for these multiple implementations are readily understood and appreciated by one skilled in the art.

Pursuant to this example, using a Universal Mobile Telecommunications System Terrestrial Radio Access Network (“UTRAN”) 12, a mobile station 14 with its own TCP receiver 16 is linked to a TCP transmitter 18 over the Internet 20. In particular, the mobile station 14 specifically communicates with the TCP transmitter 18 using a base station 20, which is controlled by a radio network controller (“RNC”) 22 in the UTRAN 12. This is an illustration of a typical communication system 10 using UTRAN 12 and the Internet 20. Any network that connects to a network using the TCP, however, is contemplated. In one embodiment, the various teachings described are implemented in the radio network controller. Depending upon the implementation of the networks and systems, other components can also be used to implement the various embodiments of the present invention. As a result, these various implementations according to the various networks and/or components of the networks are within the present scope of the invention, but as an example, the various teachings described will be based on an implementation in the RNC 22.

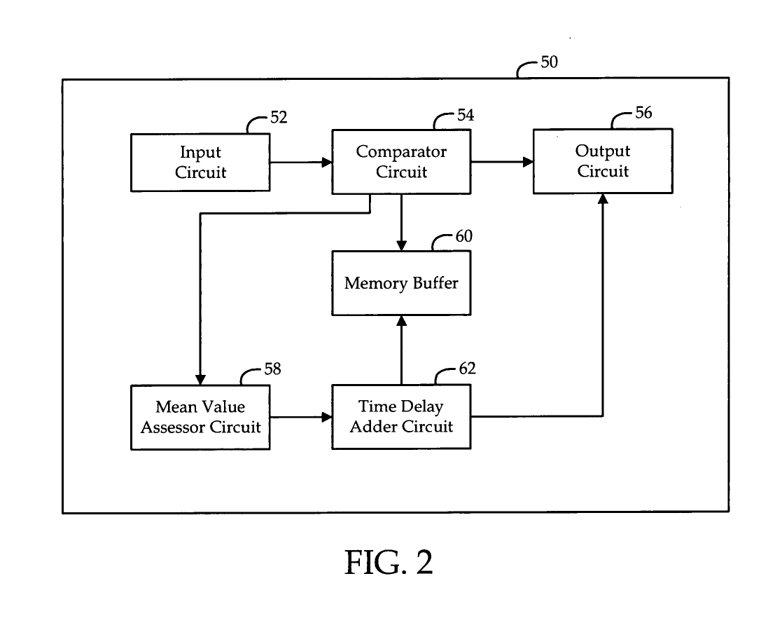

Turning now to FIG. 2, a block diagram of a controller circuit of the RNC according to various embodiments is shown and indicated generally at 50. Data packets are received through an input circuit 52, and using a comparator circuit 54 the data packets or tracked values of the data packets are routed to various components in the controller circuit 50. In one embodiment, the comparator circuit 54 checks to determine whether a particular data packet has been received previously. If so, the comparator circuit 54 immediately routes the data packet to an output circuit 56 that, in turn, routes the data packet to its proper destination.

For new data packets, the comparator circuit 54 may obtain the arrival time of a data packet and/or an assigned departure time of an acknowledgement packet corresponding to that data packet and forward these values to a mean value assessor circuit 58, which keeps track of the RTT of the data packets. The acknowledgement packet is also forwarded to a memory buffer 60 that temporarily stores the acknowledgement packet before being forwarded to the output circuit 56. A time delay adder circuit 62 is operably coupled to both the mean value assessor circuit 58 and the memory buffer 60. From the output of the mean value assessor circuit 58, a time delay is assessed and added to the assigned departure time of the acknowledgment packet by the time delay adder 62. Specifically, the time delay adder circuit 62 obtains the acknowledgement packet from the memory buffer 60 and adds the time delay to the acknowledgement packet, which is then forwarded to the output circuit 56 for transmission with the delay value. In one embodiment, the added time delay is also outputted to the mean value assessor circuit 58, which uses the added time delay to assess a mean variance time value and a mean delay value. Of course, as one skilled in the art would readily appreciate, other arrangements and configurations of the controller circuit 50 are available, and they are within the scope of the various teachings described.

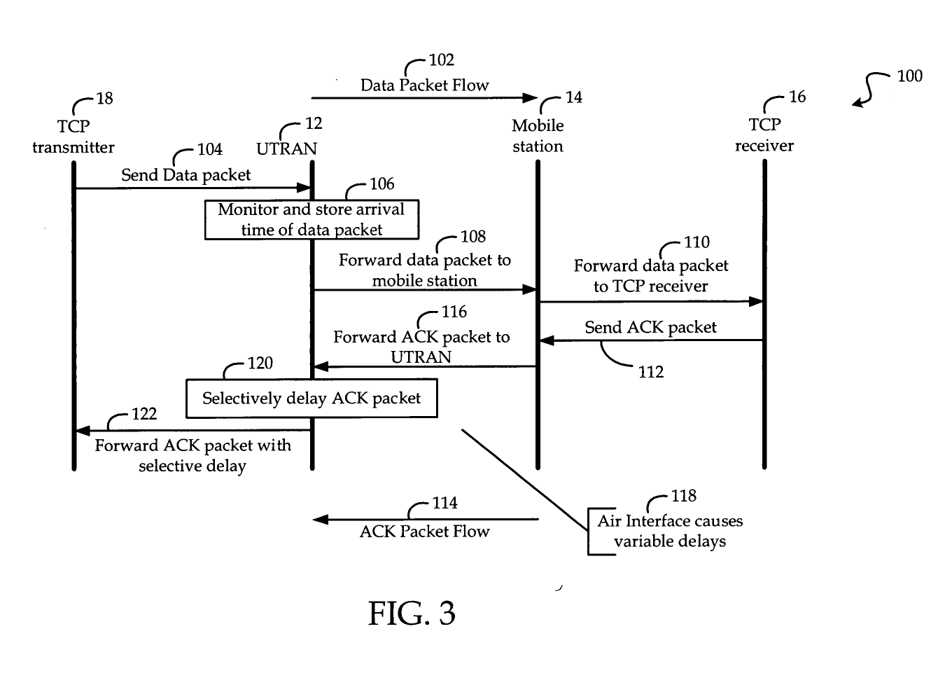

Turning now to FIG. 3, a signal flow diagram of a transmission call process according to various embodiments of the invention is shown and indicated generally at 100. As an example, a data packet flow 102 starts from the TCP transmitter 18 sending 104 a data packet to the UTRAN 12, which monitors and stores 106 the arrival time of the data packet. The data packet is forwarded 108 to the mobile station 14, which is, in turn, forwarded 110 to the TCP receiver 16 of the mobile station. In response to the data packet from the TCP transmitter 18, the TCP receiver sends 112 an acknowledgement packet that corresponds to the data packet received to the mobile station 14, which starts the acknowledgement packet flow 114. The mobile station 14 then accordingly forwards 116 the acknowledgement packet to the UTRAN 12. The link between the mobile station 14 and the UTRAN 12 may be interrupted, which may cause the acknowledgement packet to be delayed for a short time. Thus, the mobile station 14 may retransmit this acknowledgment packet in light of the interruption, which may result in a variable delay 118 caused by the air interface.

Upon receiving the acknowledgement packet, the UTRAN selectively delays 120 the acknowledgment packet to properly account for the variable delay caused by the air interface. The acknowledgement packet with the added time delay is then forwarded 122 to the TCP transmitter 18. Because of the time delay being added to the acknowledgement packet, the TCP transmitter will generate RTTs that are more stable or steady instead of sudden peaks that may result from the normal operation of the UTRAN. The RTT, as commonly known in the art, is based on a difference of the arrival time of the data packet and the arrival time of the acknowledgment packet corresponding to the data packet. In essence, the time delay added to the acknowledgement packet makes the TCP transmitter think that the UTRAN is communicating with it at a stable throughput rate, and as a result, the congestion protocol feature of the TCP would not be triggered. Moreover, because the time delay is based on mean variance and mean delay of the system RTTs of substantially all of the other acknowledgment packets, real network congestion caused by a RTT can be accounted for. Thus, when a true network congestion occurs in the UTRAN, the TCP would still be able to properly detect and respond because the mean values would be less likely to filter out a peak RTT caused by a true network congestion packet.

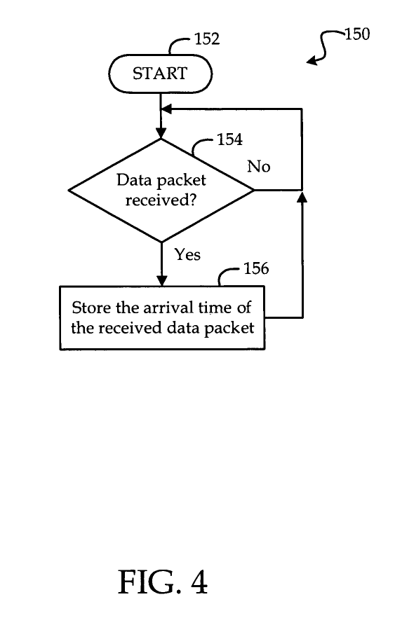

Referring now to FIG. 4, a flow chart diagram of a receiving process of a data packet according to various embodiments of the invention is shown and indicated generally at 150. As previously mentioned, the various embodiments shown are configured for an implementation with the RNC 22. A skilled artisan can readily appreciate minor alternations to any of the processes shown in order to accommodate the specific implementations. As a result, these processes are presented to give a practical illustration of the various teachings. They, however, are not limited to the processes shown, and other embodiments, although not specifically shown, are within the scope of the various teachings. Moreover, the processes described can run simultaneously because each process may be effected independently from other processes.

In this example, the process is initiated 152 by the RNC first determining 154 whether a data packet has been in fact received. If not, the RNC keeps checking until a data packet is received. Responsive to the receipt of a data packet, the RNC stores 156 the arrival time of the data packet in a data structure, such as a table or database. The process then reloops to keep checking for other data packets.

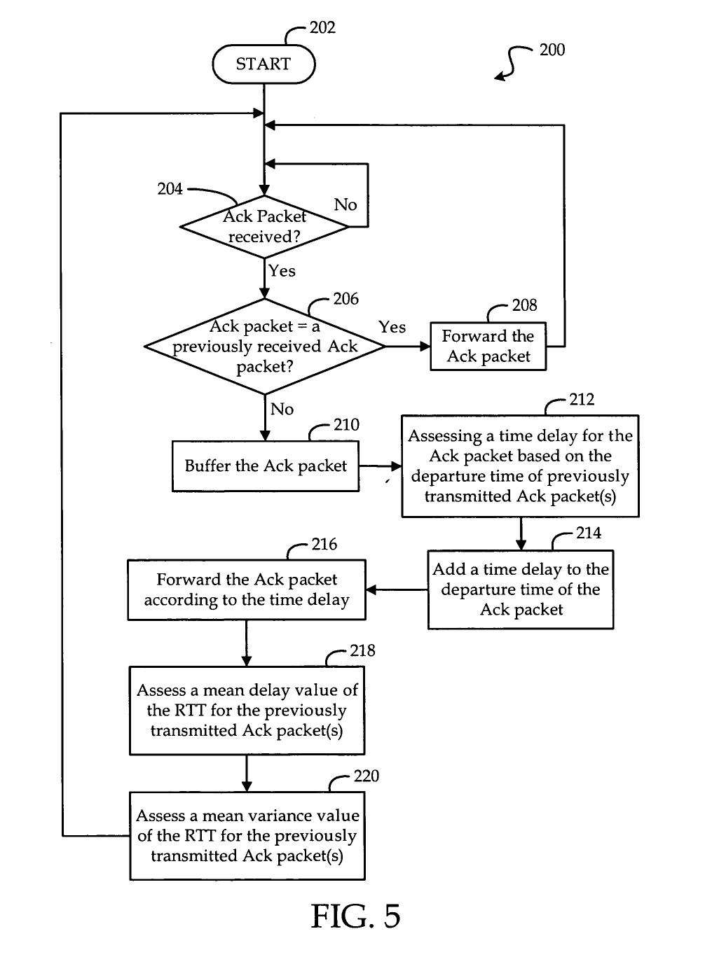

Turning now to FIG. 5, a flow chart diagram of a receiving process of an acknowledgement packet according to various embodiments of the invention is shown and indicated generally at 200. This process is similarly initiated 202 by determining 204 whether an acknowledgement packet has been received by the RNC. If not, the RNC keeps checking until an acknowledgement packet has been received by the process. Once an acknowledgement is received, the acknowledgment packet is checked to determine 206 whether it is a previously received acknowledgement packet. In other words, the process checks to see if the acknowledgment packet is just a retransmission of a previously received acknowledgement packet. If so, which means that the acknowledgment packet has already been processed previously, the acknowledgment packet is forwarded 208 for transmission. Otherwise, the acknowledgement packet is buffered 210 in the memory buffer.

The RNC next assesses 212 a time delay for the acknowledgment packet, and the time delay is based on the departure time of at least one previously transmitted acknowledgement packet in this embodiment. For example, the time delay may be based on an immediately previously transmitted acknowledgement packet. In another embodiment, the time delay can be based on all the previously transmitted acknowledgement packets. In this embodiment, the time delay is based on a mean delay of the RTTs of the previously transmitted acknowledgement packets, which is one of the many ways to assess the time delay. One of the main points of the time delay is to substantially prevent the congestion control feature of the TCP from operating based on a false network congestion detection by creating a stabilized system of RTTs in the TCP. In fact, the number of possible ways to assess the time delay are practically limitless, but these various alternative embodiments are readily appreciated by one skilled in the art. As a result, they are within the present scope of the various teachings.

Once the time delay has been assessed 212, it is added 214 to the assigned departure time of the acknowledgement packet. The acknowledgement packet is then accordingly forwarded 216 based on the time delay. Since another acknowledgement packet has been forwarded based on a time delay, a mean delay value based or partly based on the transmitted acknowledgement packet will be assessed 218, followed by a mean variance value being assessed 220 from the change. The mean delay value and the mean variance value, in this embodiment, are obtained using the RTT of this transmitted acknowledgement packet and the RTTs of other previously transmitted acknowledgement packets.

In the prior art, the acknowledgement are simply forwarded without adding any adjustment of a time delay, which inevitably creates a delay variation that the TCP transmitter 18 accounts to network congestion. As a result, the TCP transmitter 18, in reaction to this delay variation, reduces the throughput rate of the transmission. This happens regardless of whether or not there is true network congestion. Even worse, the reduction of the throughput rate does not reduce the delay but in fact hinders the utilization of the radio bearer. The added time delay, however, is able to adjust the RTTs to give the TCP transmitter 18 an appearance of a stable transmission throughput, which effectively prevents the trigger of the congestion control feature of the TCP based on a false detection of network congestion.

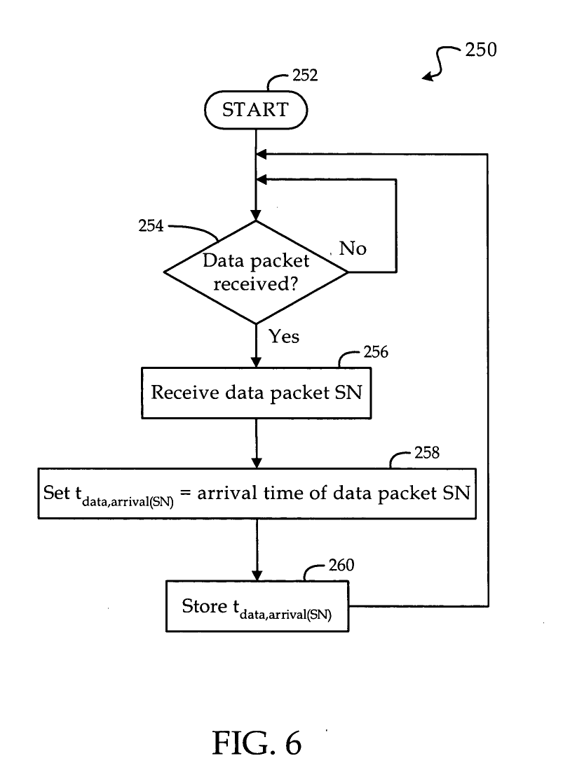

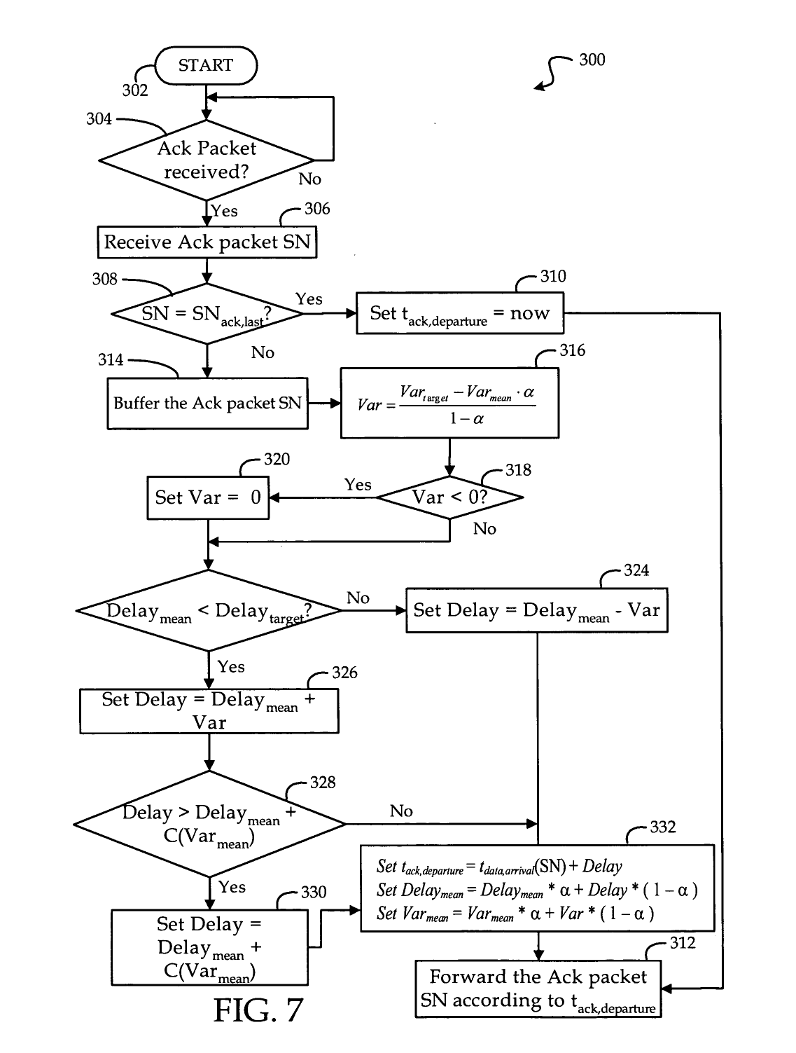

Turning now to FIG. 6, a flow chart diagram of a receiving process of a data packet according to an embodiment of the invention is shown and indicated generally at 250. The processes shown in FIGS. 6 and 7 are also an implementation of the RNC. In an attempt to show a specific example of the various teachings, specific mathematical parameters and formulas are included as examples. A skilled artisan, however, can readily appreciate other mathematical formulas and parameters to effectuate a process that prevents a false trigger of the congestion control feature of the TCP transmitter.

This process begins 252 by determining 254 whether a data packet has been received by the RNC. If not, the process keeps checking for the arrival of a data packet. If, however, a data packet, which generally bears a specific sequence number (“SN”), is received 256, the arrival time of the received data packet SN is set 258 to parameter t_{data, arrival(SN)}, which is a time of arrival record of data packet SN. The parameter t_{data,arrival(SN)} is stored 260 to a data structure as a record of the data packet SN's arrival time to the RNC. The process re-loops to check for the receipt of more data packets.

Referring to FIG. 7, a flow chart diagram of a receiving process of an acknowledgement packet according to an embodiment of the invention is shown and indicated generally at 300. The process starts 302 with a check to determine 304 whether an acknowledgment packet has been received at the RNC. If not, the process re-loops until an acknowledgment packet has in fact been received. As an example, an acknowledgement packet that corresponds to the data packet SN received in FIG. 6 would be processed. In this case, an acknowledgment packet SN is received 306. The RNC next determines whether the acknowledgement packet SN has previously been received by the process, specifically it is determined 308 whether the received media sequence number of this acknowledgment packet SN has the same sequence number of a previously transmitted acknowledgement packet (e.g., SN=SN_{ack, last}). This will also check whether this particular acknowledgement packet SN has already been processed. If so, the departure of this acknowledgement packet SN (t_{ack, departure}) is set 310 to the current time, which will forward the acknowledgement packet immediately without delay. The acknowledgement packet SN is then forwarded 312 according to tack, departure, which does not include, in this case, a delay value. The process re-loops to check for more acknowledgement packets.

If, however, SN does not equal SN_{ack, last}, the acknowledgement packet is buffered 314 for a delay value to be assessed. In particular, a variance value is calculated and set 316 based on the formula

$$Var = \frac{{Var}_{target} - {Var}_{mean} * α}{1 - α} \qquad ( 1 )$$

where Var is the variance value, Var_{target} is a target variance value, Varₘₑₐₙ is a mean variance value, and α is a predefined filter coefficient. The target variance Var_{target} and filter coefficient α are predefined values, and Varₘₑₐₙ is a calculated mean value of a variance of all the RTTs, which are based on the arrival time of the data packets and the arrival time of their corresponding acknowledgement packets (without the added delay). The target variance Var_{target} is used as a means for creating a stable RTT of the system. Essentially, the natural mean delay and delay variance are hidden from the TCP transmitter by substituting the target variance value Var_{target} and a target delay value Delay_{target}, which are predefined values in one embodiment. Any of these target values are configurable for optimal tuning of specific systems and their corresponding characteristics. The filter coefficient α, which can range from 0 and 1 in one embodiment, is used to control an “Infinite Impulse Response” (“IIR”) filter. High range values can produce a more stable output by putting more weight on the existing mean, and low values produce a mean that responds more quickly to changes in the input. The mean variance Varₘₑₐₙ is based on the formula
Varₘₑₐₙ=Varₘₑₐₙ* α+Var*(1−α) (2)

Next, the variance value Var is then compared to determine 318 whether it is less than zero. If the variance value Var is less than zero, the variance value Var is set 320 to zero, since in this embodiment, the variance value Var is preferably a non-negative number. Once it is ensured that the variance value Var is a non-negative number, the RNC determines 322 whether a mean delay value Delayₘₑₐₙ is less than a target delay value Delay_{target}. The target delay value Delay_{target} is a predefined value, which is specific to the implementation. The mean delay value Delayₘₑₐₙ, on the other hand, is a calculated mean value of a time delay of the system RTTs of the data packets and their corresponding transmitted acknowledgement packets in the system. For this step, the currently received acknowledgement packet SN has not yet been accounted for in the value of the mean delay value Delayₘₑₐₙ. If the mean delay value Delayₘₑₐₙ is not less than the target delay value Delay_{target}, a delay value Delay is set 324 according to the formula
Delay=Delayₘₑₐₙ−Var (3)

If, on the other hand, the mean delay value Delayₘₑₐₙ is less than the target delay value Delay_{target}, the delay value Delay, instead, would be set 326 according to the formula
Delay=Delayₘₑₐₙ+Var (4)

Once the delay value Delay is set 326, the RNC next determines 328 whether it is greater than a calculated mean value based on the formula
Delay=Delayₘₑₐₙ+C(Varₘₑₐₙ) (5)
where C is a constant. If so, the delay value Delay will be set 330 according to this formula. If not, multiple parameters will be set 332 according to the following formulas:
t_{ack,departure}=t_{data,arrival}(SN)+Delay (6)
Delayₘₑₐₙ=Delayₘₑₐₙ*α+Delay*(1−α) (7)
Varₘₑₐₙ=Varₘₑₐₙ*α+Var*(1−α) (8)

The acknowledgement packet SN is then forwarded 312 according to the new departure time, which includes the departure time previously assigned to the acknowledgement packet upon its arrival and the calculated delay value. The process than re-loops to check for more acknowledgement packets.

With these various teachings shown, a novel RTT management technique of the TCP has been provided. As a result of the various teachings shown, the delay variations, which are caused by the normal operation of the wireless network, are stabilized to prevent the TCP from triggering the congestion control feature based on false detections of network congestion. This is so because the TCP sees a stable pattern of transmission delay instead of interruptions and peaks. Since the TCP does not interpret the steady delay as network congestion, the congestion control feature will not be falsely triggered. It is important to prevent such false triggers of the congestion control feature of the TCP because not only does it not improve the delay, it also reduces the utilization of the radio bearer. As a result, the radio bearer can be used with higher utilization in addition to the TCP throughput being increased.

The various embodiments of the delay value shown, nevertheless, provide a way to account for real network congestion. In other words, true network congestion, which would benefit from the congestion control feature of the TCP, is not unnecessarily filtered and it is accounted for in the various embodiments. As a result, the various teachings are able to take advantage of the congestion control feature of the TCP while integrating seamlessly into the normal operation of the wireless network. Moreover, the implementation is both easy and unrestrictive because the characteristics of the wireless network are modified to work with the existing TCP implementations. Thus, fuller use of the radio bearers is allowed to connect with the TCP entities on the Internet without requiring changes to those TCP entities. This would positively affect common key performance indicators, such as the file transfer protocol (“FTP”) download rate and hypertext transfer protocol (“HTTP”) load time.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method of managing round trip time of a transmission control protocol comprising:
receiving an acknowledgement packet;
buffering the acknowledgement packet into a memory buffer; and
adding a time delay to an assigned departure time of the acknowledgement packet.

2. The method according to claim 1, wherein the time delay is selected to at least substantially prevent a congestion control feature of the transmission control protocol based on a false detection of a network congestion.

3. The method according to claim 1, wherein the time delay is selected to stabilize round trip times of the transmission control protocol to prevent a false detection of a network congestion.

4. The method according to claim 1, wherein the time delay is based on any one or more selected from a group of a mean delay value and a mean variance value.

5. The method according to claim 1 further comprising:
tracking an arrival time of a data packet corresponding to the acknowledgement packet; and
storing the arrival time of the data packet to a data structure.

6. The method according to claim 1 further comprising:
assessing a mean delay value obtained from a plurality of system round trip times of other acknowledgement packets; and
assessing a mean variance value obtained from the plurality of system round trip times of other acknowledgement packets.

7. The method according to claim 1 further comprising:
forwarding the acknowledgement packet according to the delay.

8. The method according to claim 1, wherein buffering the acknowledgement packet into a memory buffer further comprises:
determining whether the acknowledgement packet has been previously received;
forwarding the acknowledgement packet when the acknowledgement packet has been previously received; and
buffering the acknowledgement packet into the memory buffer when the acknowledgement packet has not been previously received.

9. The method according to claim 1, wherein adding a time delay to an assigned departure time of the acknowledgement packet further comprises:
assessing a variance value based on a mean variance value obtained from a plurality of system round trip times of other acknowledgement packets and a packet variance value obtained from a round trip time of the acknowledgement packet.

10. The method according to claim 9, wherein the packet variance value is further based on a predefined target variance value.

11. The method according to claim 9, wherein the variance value is further based on a filter coefficient.

12. The method according to claim 9, wherein adding a time delay to an assigned departure time of the acknowledgement packet further comprises:
determining whether a mean delay value obtained from the plurality of system round trip times of other acknowledgement packets corresponds in at least a predetermined way to a predefined target delay value;
assessing a delay value by adding the variance value to the mean delay value when the mean delay value corresponds in at least the predetermined way to the predefined target delay value; and
assessing the delay value by subtracting the variance value from the mean delay value when the mean delay value does not correspond in at least the predetermined way to the predefined target delay value.

13. The method according to claim 12, wherein assessing the time delay value by adding the variance value to the mean delay value further comprises:
determining whether the delay value corresponds in at least a predetermined way to a mean value based on the mean delay value and the mean variance value; and
setting the delay value to the mean value when the delay value corresponds in at least a predetermined way to the mean value based on the mean delay value and the mean variance value.

14. The method according to claim 13 further comprising:
forwarding the acknowledgement packet based on the delay value.

15. The method according to claim 1, wherein prior to adding the time delay to the assigned departure time of the acknowledgement packet further comprising:
assessing the delay based on a departure time of at least one previously transmitted acknowledgement packet.

16. An apparatus for managing round trip time of a transmission control protocol comprising:
a memory buffer having an acknowledgement packet; and
a time delay adder circuit operably coupled to the memory buffer and having an added delay value to an assigned departure time to the acknowledgement packet.

17. The apparatus as defined in claim 16 further comprising:
a mean value assessor circuit operably coupled to the time delay adder circuit and having a mean delay value and a mean variance value obtained from a plurality of system round trip times of other acknowledgement packets; and
an output circuit operably coupled to the time delay adder circuit that forwards the acknowledgement packet according to the added delay value to the assigned departure time.

18. The apparatus as defined in claim 16, wherein the time delay adder circuit comprises a means for adding the added time delay value to the assigned departure time of the acknowledgement packet.

19. A system of managing round trip time of a transmission control protocol comprising:
a transmission control protocol transmitter;
a transmission control protocol receiver; and
a controller circuit operably coupled to the transmission control protocol transmitter and the transmission control protocol receiver, wherein the controller circuit buffers at least one acknowledgement packet from the receiver and adds a delay to an assigned departure time of the at least one acknowledgement packet for transmission to the transmitter.
